(19) United States
(12) Patent Application Publication
(10) Pub. No.: US 2011/0145244 A1
(43) Pub. Date: Jun. 16, 2011

(54) MULTI-DIMENSIONAL HISTOGRAM METHOD USING MINIMAL DATA-SKEW COVER IN SPACE-PARTITIONING TREE AND RECORDING MEDIUM STORING PROGRAM FOR EXECUTING THE SAME

(75) Inventors: Myoung Ho Kim, Daejon (KR); Yohan J. Roh, Daejon (KR); Jae Ho Kim, Icheon-si (KR); Jin Hyun Son, Uiwang-si (KR)

(73) Assignee: KOREA ADVANCED INSTITUTE OF SCIENCE AND TECHNOLOGY, Daejon (KR)

(21) Appl. No.: 12/695,500

(22) Filed: Jan. 28, 2010

(30) Foreign Application Priority Data
Dec. 15, 2009 (KR) 10-2009-0124523

(51) Int. Cl. G06F 17/30

(52) U.S. Cl. 707/737; 707/769; 707/E17.014; 707/E17.012; 707/797; 707/E17.005; 707/E17.089

(57) ABSTRACT

The present disclosure relates to a multi-dimensional histogram method using a minimal data-skew cover in a space-partitioning tree, which is used to estimate the selectivity of queries, that is, the sizes of query results, and a recording medium storing a program for executing the multi-dimensional histogram method. In the multi-dimensional histogram method, a Database (DB) system receives information required to generate a histogram from an outside of the DB system, and then constructs a space-partitioning tree based on the information required to generate a histogram. The DB system constructs a multi-dimensional histogram based on a minimal data-skew cover in the space-partitioning tree. When the DB system receives a query from the outside, the DB system calculates the estimate of the selectivity for the query by using the multi-dimensional histogram. Further, the present disclosure includes a recording medium storing a program for executing the multi-dimensional histogram method.

### BACKGROUND

1. Field

The present application relates, in general, to a multi-dimensional histogram method, which estimates the selectivity of multi-dimensional queries and a recording medium storing a program for executing the multi-dimensional histogram method.

2. Description of the Related Art

The estimation of the selectivity of range queries, i.e., the sizes of the query results, can be used in areas such as database query optimization, approximate query processing in data warehouses, and skyline query processing. Motivated by these applications, there has been much work on the problem of selectivity estimation. Among existing techniques, multi-dimensional histograms have been a popular way to obtain estimates of selectivity for multi-dimensional range queries.

The multi-dimensional histogram method will be described in detail below. A histogram includes of a set of buckets Bᵢ (i=1, 2, . . . , n), where each Bᵢ has a hyper-rectangle region Sᵢ and an object frequency Fᵢ, i.e., the number of data objects in Sᵢ. The number of buckets is usually a system parameter and is reasonably small so that all the buckets can be kept in main memory. The process of constructing a histogram is typically performed periodically to reflect changes in the underlying data distribution.

Given a range query, the selectivity of the query is computed based on the assumption that data objects in each bucket are uniformly distributed. When data objects are not uniformly distributed in buckets, the accuracy of a histogram will decrease. A histogram, therefore, should be organized in such a way that data in each bucket is as uniformly distributed as possible. However, it has been shown to be intractable to organize histogram buckets such that data objects in every bucket are uniformly distributed. Thus, in most heuristic histogram methods, there often exist data skews in buckets, which may seriously degrade estimation accuracy.

The present application discloses a new multi-dimensional histogram method and a recording medium storing a program for executing the method as follows.

### SUMMARY

Accordingly, keeping in mind the above problems of conventional histogram methods in which the accuracy of selectivity estimation using a histogram may be deteriorated due to data skews in buckets, the present disclosure, in one aspect, provides a skew-tolerant multi-dimensional histogram method and a recording medium storing a program for executing the multi-dimensional histogram method, in which the buckets of a histogram are effectively constructed on the basis of a minimal data-skew cover in a space-partitioning tree which partitions a given data space into areas having various sizes, thus providing better performance with respect to the accuracy of selectivity estimation.

In order to accomplish the above aspect, the present invention may provide a multi-dimensional histogram method, comprising (a) a database (DB) system receiving information required to generate a histogram from an outside of the DB system, and then constructing a space-partitioning tree based on the information required to generate a histogram; (b) the DB system constructing a multi-dimensional histogram based on a minimal data-skew cover in the space-partitioning tree; and (c) the DB system receiving a query from the outside, and then estimating the selectivity of the query by using the multi-dimensional histogram.

The information required to generate the histogram may comprise one or more of an entire data space, a data set, a maximum number of buckets, and an index structure.

In an embodiment, (a) may comprise (a-1) the DB system receiving the entire data space, the data set and the maximum number of buckets as the information required to generate a histogram from the outside, and then partitioning the entire data space into one or more areas; (a-2) the DB system computing the Minimum Bounding Regions (MBRs) of data objects in the partitioned areas, and constructing a space-partitioning tree, based on the computed MBRs; and (a-3) calculating data skew values of respective nodes included in the space-partitioning tree.

In another embodiment, (a) may comprise (a′-1) the DB system receiving the index structure, the data set, and the maximum number of buckets as the information required to generate a histogram from the outside, and then using the index structure as a space-partitioning tree; and (a′-2) calculating data skew values of respective nodes included in the space-partitioning tree.

In an embodiment, (b) may comprise (b-1) the DB system searching the space-partitioning tree for covers of the space-partitioning tree; (b-2) the DB system determining a minimal data-skew cover with respect to a given cover in the space-partitioning tree, depending on whether a number of nodes included in the given cover in the space-partitioning tree is less than or equal to the externally received maximum number of buckets and whether a sum of data skew values of the respective nodes included in the given cover in the space-partitioning tree is a minimal value; and (b-3) the DB system constructing a multi-dimensional histogram by organizing the nodes included in the minimal data-skew cover into histogram buckets.

In an embodiment, (c) may be performed such that, for a data region I specified by a given range query, an estimate of the selectivity for the query is computed using the following equation:

$$estimate of the selectivity for a range query = {\sum }_{i = 1 … n} \frac{\vert {S}_{i} ⋀ I \vert}{\vert {S}_{i} \vert} \cdot {F}_{i} ,$$

where ‘| |’ denotes a size of a data space and ‘Sᵢ [symbol] I’ denotes intersection of Sᵢ and I. From the above equation, it can be seen that an estimate of selectivity for one bucket is computed in proportion to the size of the overlapping region between the query region and the bucket region. The selectivity estimate for a range query is the sum of all the estimated values for all the buckets.

### BRIEF DESCRIPTION OF THE DRAWINGS

FIG. 1 is a flowchart showing the overall flow of the multi-dimensional histogram method according to one embodiment of the present invention;

FIG. 2A is a diagram showing the multi-dimensional histogram method according to an embodiment of the present invention;

FIG. 2B is another diagram showing the multi-dimensional histogram method according to an embodiment of the present invention; and

FIG. 2C is a further diagram showing the multi-dimensional histogram method according to an embodiment of the present invention.

FIG. 3A shows an algorithm in one embodiment for calculating the data skew value of a minimal data-skew cover in a given space-partitioning tree.

FIGS. 3B-1 and 3B-2 show an algorithm in one embodiment for searching a given space-partitioning tree for a minimal data-skew cover.

### DESCRIPTION OF THE EMBODIMENTS

Prior to giving the description, it should be noted that components not directly related to the gist of the present invention will be omitted without departing from the scope of the present invention. Further, the terms and words used in the present specification and claims should be interpreted to have the meaning and concept relevant to the technical spirit of the present invention, on the basis of the principle by which the inventor can suitably define the implications of terms in the way which best describes the invention.

Hereinafter, a method of calculating a data skew value of a given bucket in the present disclosure will be described, prior to describing a multi-dimensional histogram method using a minimal data-skew cover in a space-partitioning tree according to one embodiment of the present invention.

A given space is assumed to be a d-dimensional grid space. Each cell in the grid space is assumed to be capable of including one or more data objects. The region of a bucket include of one or more grid cells.

In the prior art, the data skew value of a bucket is usually calculated using the standard deviation (or variance) of the frequencies of data objects in all the grid cells included in the bucket.

A slightly different measure of the skew of a bucket will be described below. In the case where the region of a bucket partially overlaps with the region of a given query, the accuracy of the estimate of the selectivity for the bucket is affected by the standard deviation of the frequencies of data objects in all the cells of the bucket. In other case where the region of a bucket is completely contained in the given query region, the skew of this bucket has nothing to do with the accuracy of the estimate of the selectivity for the bucket. In other words, this bucket behaves as if there were no data skew. In general, as the size of a bucket region decreases, the probability that the bucket region is completely contained in a given query region increases.

A new measure of the skew of a bucket in the present disclosure is based on the fact that the effect of the skew tends to decrease as the size of the region of a bucket decreases.

In the present disclosure, a data skew value of a bucket b, denoted by wSkew(b), may be calculated by the following Equation (1),

wSkew(b)=size(b)×sd(b), (1)

where ‘size(b)’ denotes the size of the region of bucket b, and ‘sd(b)’ denotes the standard deviation of the frequencies of data objects in all the grid cells included in the bucket b.

The data skew value of a node in a space-partitioning tree may be calculated using the same method as the method of calculating the data skew value of a histogram bucket shown in Equation (1). However, any other method for measuring the skew of a bucket or node may be employed.

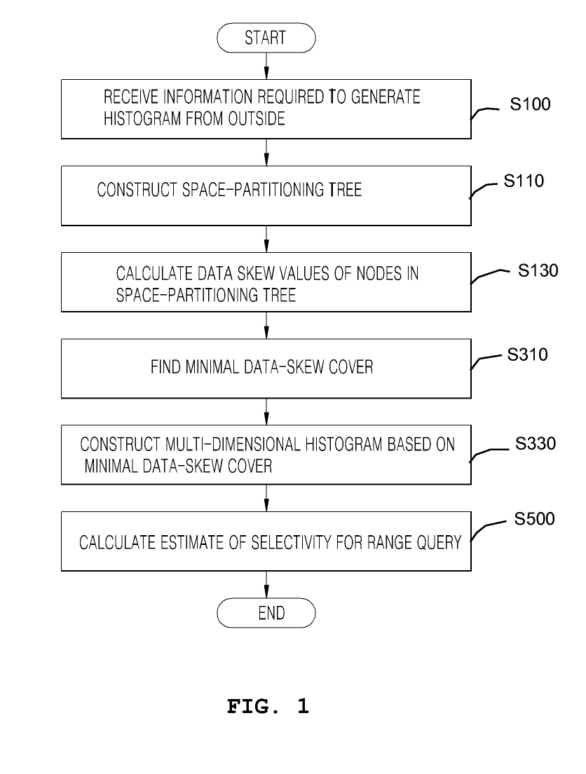

Hereinafter, the overall flow of the multi-dimensional histogram method using a minimal data-skew cover in a space-partitioning tree according to the present disclosure will be described in detail with reference to the attached drawings. FIG. 1 is a flowchart showing the overall flow of the multi-dimensional histogram method.

First, a database (DB) system receives information required to generate a histogram from the outside of the DB system at step S100.

Here, the information required to generate a histogram may include one or more of an entire data space, a data set, the maximum number of buckets, and an index structure. The entire data space refers to any space including given data objects. The data set refers to a set of the given data objects. The maximum number of buckets refers to the maximum number of buckets allowed in the multi-dimensional histogram according to the present disclosure. The index structure refers to a tree-like index structure in the DB system that has already been created.

Next, at step S110, the DB system constructs a space-partitioning tree based on the externally received information required to generate the histogram.

In the case where the DB system receives an entire data space, a data set, and the maximum number of buckets as the information required to generate a histogram, the DB system may construct a space-partitioning tree by partitioning the entire data space, which is included in the information required to generate a histogram, into one or more areas, computing the Minimum Bounding Regions (MBRs) of data objects in the areas, and constructing a space-partitioning tree of nodes, each of which corresponds to one of the computed MBRs.

In other case where the DB system receives a tree-like index structure, an entire data space, a data set, and the maximum number of buckets as the information required to generate a histogram, the DB system may use the tree-like index structure as a space-partitioning tree.

Next, at step S130, the DB system calculates the data skew values of respective nodes included in the space-partitioning tree.

Next, at step S310, the DB system searches the space-partitioning tree for a minimal data-skew cover among all the covers in the space-partitioning tree.

Next, at step S330, the DB system organizes all the nodes included in the minimal data-skew cover into histogram buckets and constructs a multi-dimensional histogram.

At step S500, whenever receiving a range query from the outside of the DB system, the DB system calculates an estimate of the selectivity for the query by using the constructed multi-dimensional histogram, and thereafter terminates the above process.

Hereinafter, the multi-dimensional histogram method using a minimal data-skew cover in a space-partitioning tree will be described in detail.

The multi-dimensional histogram method using a minimal data-skew cover in a space-partitioning tree may include the step (a) of the DB system receiving information required to generate a histogram from the outside of the DB system, and then constructing a space-partitioning tree on the basis of the information required to generate a histogram; the step (b) of the DB system constructing a multi-dimensional histogram on the basis of a minimal data-skew cover in the space-partitioning tree; and the step (c) of the DB system receiving a range query from the outside of the DB system, and then estimating the selectivity of the range query by using the multi-dimensional histogram.

Step (a) may include the step (a-1) of the DB system receiving an entire data space, a data set, and the maximum number of buckets as the information required to generate the histogram from the outside of the DB system, and then partitioning the entire data space into one or more areas; the step (a-2) of the DB system computing MBRs of data objects included in the partitioned areas, and constructing a space-partitioning tree of nodes, each corresponding to one of the computed MBRs; and the step (a-3) of calculating the data skew values of respective nodes included in the space-partitioning tree.

At step (a-1), a method by which the DB system partitions the entire data space into one or more areas may be implemented using a binary space partitioning or a complete quadtree partitioning described below.

The partitioning of a region is said to be a binary space partitioning if there can be found a certain hyperplane that has the form of xᵢ=c (xᵢ is a dimensional axis, and c is a constant), by which the input region is divided into two sub-regions such that the partitioning of the two sub-regions is also binary space partitioning.

The complete quadtree partitioning is a space partitioning method in which a given region in a d-dimensional space is partitioned into 2^{d} disjoint, equal-sized sub-regions whenever partitioning is performed; in the two-dimensional case, a region is partitioned into quadrants.

However, at step (a-1), any other space-partitioning method may be employed.

Further, at step (a-2), the term ‘Minimum Bounding Region (MBR)’ denotes a minimum region that includes all the data objects in an area resulting from step (a-1).

Furthermore, at step (a-2), all the nodes constituting the space-partitioning tree are formed to correspond to the above-described MBRs and may be numbered based on the postorder traversal.

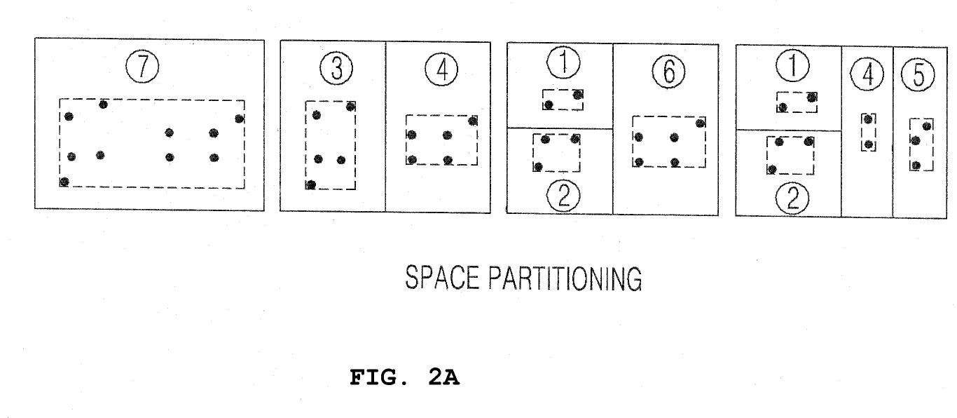

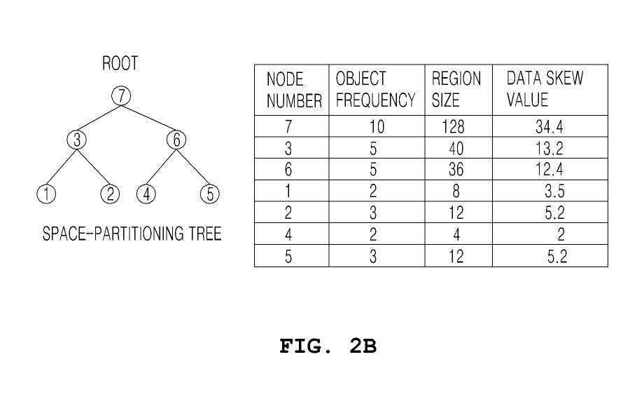

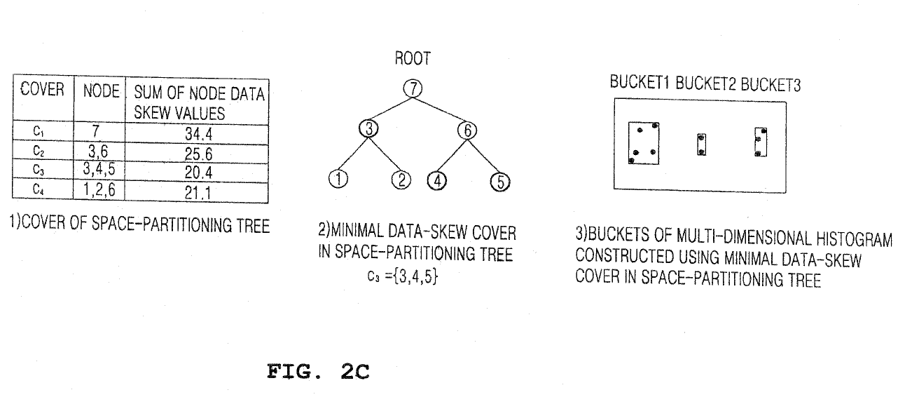

For example, referring to FIG. 2A, it can be seen that a total of seven MBRs are constructed by space partitioning. Referring to FIG. 2B, it can be seen that seven nodes are constructed based on the seven MBRs and are numbered consecutively by the postorder traversal, and that a space-partitioning tree whose root node is Node7 is constructed.

Further, at step (a-3), the term ‘data skew values of nodes’ denotes the values calculated in the same way as in Equation (1). However, any other method for calculating the data skew value of a node may be employed.

Furthermore, unlike the above construction of a space-partitioning tree, step (a) may also include the step (a′-1) of the DB system receiving an index structure, a data set, and the maximum number of buckets as the information required to generate a histogram from the outside of the DB system, and then using the index structure as a space-partitioning tree; and the step (a′-2) of calculating node data skew values for respective nodes included in the space-partitioning tree.

At step (a′-1), when a tree-like index structure has already been created and used for other applications, unlike the above step (a-1), the DB system may use the tree-like index structure as a space-partitioning tree. When the shapes of index nodes are hyperrectangles, any tree-like index structure can be used as a space-partitioning tree. In the two-dimensional case, the hyperrectangles may be rectangular regions.

Further, at step (a′-2), a method of calculating the data skew values of nodes is identical to that described for the above step (a-3).

Step (b) may include the step (b-1) of the DB system searching a space-partitioning tree for covers; the step (b-2) of the DB system determining a minimal data-skew cover with respect to a given cover in the space-partitioning tree depending on whether the number of nodes included in the given cover in the space-partitioning tree is less than or equal to the maximum number of buckets, and whether the sum of the data skew values of all the respective nodes included in the given cover in the space-partitioning tree is a minimal value; and the step (b-3) of the DB system constructing a multi-dimensional histogram by organizing nodes included in the minimal data-skew cover into buckets.

For a given node N, leaf-node descendants of N are defined as leaf nodes that are descendants of N. For example, when N is a leaf node, the leaf-node descendant of N is itself, i.e., N.

At step (b-1), the term “cover” in a space-partitioning tree denotes a set of nodes whose leaf-node descendants are the entire leaf nodes of the space-partitioning tree, where no two nodes in the cover have an ancestor-descendant relationship.

Further, at step (b-2), the term ‘minimal data-skew cover’ denotes a cover such that the number of nodes in the cover, each of which will be organized into a histogram bucket, is less than or equal to the maximum number of buckets and such that the sum of the data skew values of all the nodes included in the cover is a minimal value, among all the covers, whose sizes are at most the maximum number of buckets, in the space-partitioning tree.

Furthermore, at step (b-3), the DB system organizes all the nodes of the minimal data-skew cover in the space-partitioning tree, obtained from step (b-2), into the buckets of a multi-dimensional histogram, and constructs a multi-dimensional histogram consisting of these buckets.

At step (c), the DB system receives a range query from outside the DB system, and then computes the selectivity of the query by using the multi-dimensional histogram obtained from step (b).

Step (c) will be described in detail. When the multi-dimensional histogram, obtained from step (b), includes a set of buckets Bᵢ (i=1, 2, . . . , n) where each Bᵢ has a hyper-rectangle region Sᵢ and an object frequency F, an estimate of the selectivity for a given range query whose region is I, is computed as follows:

$$estimate of the selectivity for a range query = {\sum }_{i = 1 … n} \frac{\vert {S}_{i} ⋀ I \vert}{\vert {S}_{i} \vert} \cdot {F}_{i} \qquad ( 2 )$$

Here, ‘| |’ denotes the size of a data space and ‘Sᵢ [symbol] I’ denotes the intersection of Sᵢ and I.

The above-described method for selectivity estimation can also be used in estimating the selectivity of the point queries or the line queries in grid space.

Hereinafter, a process according to an embodiment of the present invention will be described in detail with reference to the attached drawings. FIGS. 2A to 2C are diagrams showing the multi-dimensional histogram method according to an embodiment of the present invention.

The embodiment of the present invention, described with reference to FIGS. 2A to 2C, corresponds to an embodiment related to the construction of a two-dimensional histogram that can be widely used in spatial databases.

However, the multi-dimensional histogram method of the present invention can be used in three- or more dimensions as well.

As shown in FIG. 2A, the DB system partitions the entire data space, received from the outside of the DB system, into a plurality of areas having various sizes. Each of rectangles indicated by dotted lines in FIG. 2A is a Minimum Bounding Region (MBR) of all the data objects in one of the partitioned area.

Next, as shown in FIG. 2B, the DB system forms these MBRs as the nodes of a space-partitioning tree that represents the containment relationships among the MBRs. The nodes of the space-partitioning tree may be numbered consecutively according to the postorder traversal. Further, for each node of the space-partitioning tree, the DB system calculates the data skew value of the node.

For example, in the present embodiment shown in FIG. 2B, it can be seen that, a total of seven nodes are constructed and numbered consecutively according to the postorder traversal. The object frequencies, sizes of regions, and data skew values of the nodes of the space-partitioning tree are shown in the right figure in FIG. 2B.

Next, as shown in FIG. 2C, the DB system searches the space-partitioning tree for a minimal data-skew cover and organizes the minimal data-skew cover into a multi-dimensional histogram.

Let us assume in FIG. 2C that the maximum number of buckets is 3. Then, according to the present embodiment shown in FIG. 2C, there are 4 covers whose sizes are at most the maximum number of buckets: cover C₁ consists of Node7, cover C₂ consists of Node3 and 6, cover C₃ consists of Node3, 4 and 5, and cover C₄ consists of Node1, 2 and 6. Among these, cover C₃ shown in the middle figure of FIG. 2C, which includes Node3, 4, and 5, is the minimal data-skew cover in the given space-partitioning tree. Each of Node3, 4, and 5 is organized into a bucket, as shown in the right figure of FIG. 2C.

Hereinafter, a recording medium storing a program for executing the multi-dimensional histogram method will be described in detail. The multi-dimensional histogram method may be implemented in the form of an executable program and may be stored in computer-readable recording media (for example, Compact Disk-Read Only Memory (CD-ROM), Random Access Memory (RAM), ROM, a floppy disk, a hard disk, a magneto-optical disk, etc.). Further, the methods described herein may be executed on a computer or the like having one or more processors or the like, that loads the instructions of the methods stored, for example, on the computer-readable recording media, to carry out the methods.

Next, the algorithm for searching the given space-partitioning tree for a minimal data-skew cover will be described in detail.

As described earlier, a minimal data-skew cover in a space-partitioning tree is a cover configured such that the number of nodes in the cover is less than or equal to the maximum number of buckets and such that the sum of the data skew values of all the nodes included in the cover is a minimal value, among all the covers, whose sizes are at most the maximum number of buckets, in the space-partitioning tree.

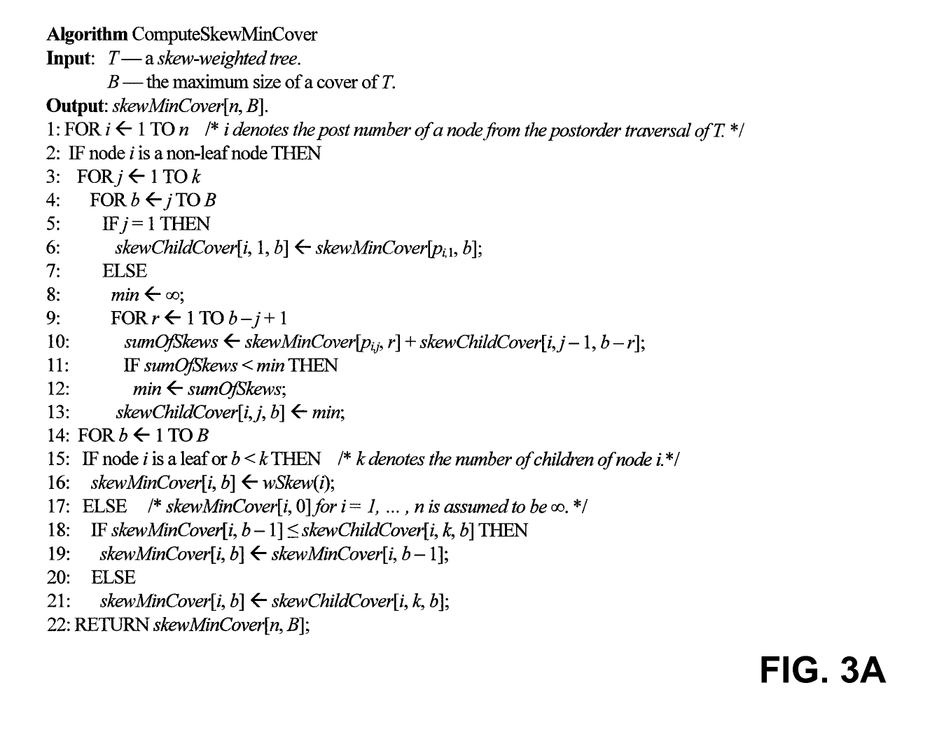

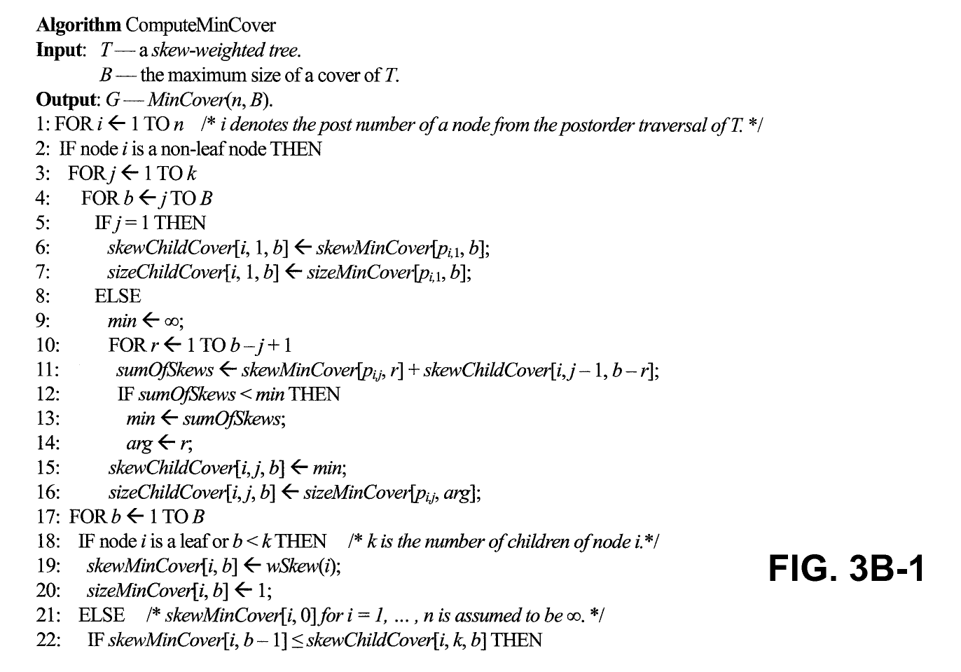

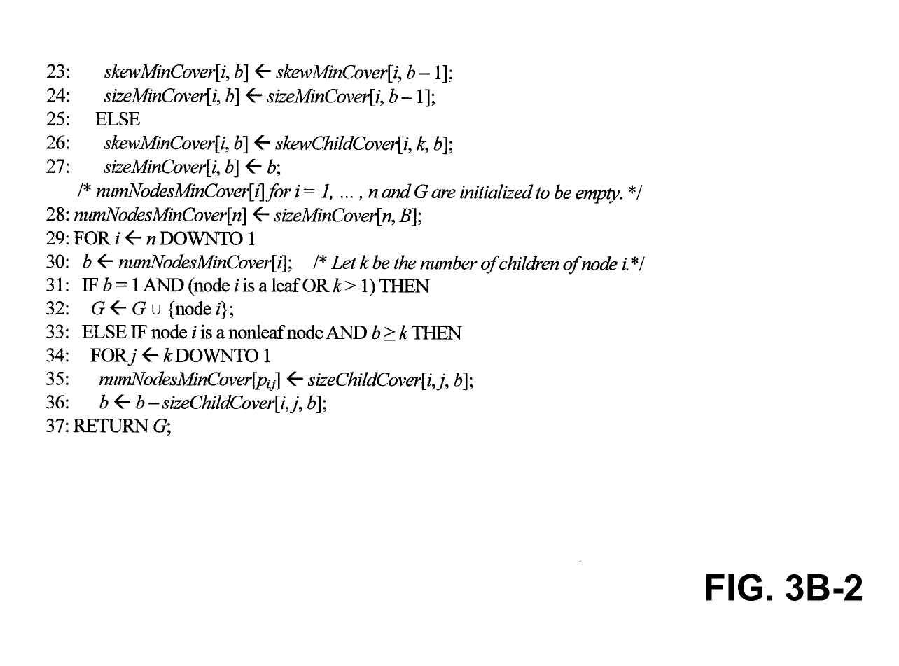

FIG. 3A shows the algorithm for calculating the data skew value of a minimal data-skew cover, and FIGS. 3B-1 and 3B-2 show the algorithm for searching for a minimal data-skew cover.

For a given space-partitioning tree T, it is assumed that each node of T is numbered with its post number ‘i’, for ‘i’=1, . . . , n, from the postorder traversal of T. For example, node n denotes the root node of T.

The data skew of a set of nodes S, denoted by wSkew(S), is defined as the sum of skews of all the nodes in S.

Let sub-tree T(i) of T denote a sub-tree rooted by node i. Then, a minimal data-skew cover of T(i), denoted by MinCover(i,b), is defined as a cover of T(i) such that the size of the cover is less than or equal to b and the data skew of the cover is a minimal value among all the possible covers of T(i) whose sizes are at most b, for b≧1. When node i is a leaf node of T, MinCover(i,b) is {i}.

Accordingly, when the externally received maximum number of buckets for a histogram is B, MinCover(n,B) denotes a minimal data-skew cover in T whose size is at most B. Let skewMinCover[i,b] denote the data skew value of MinCover(i,b), i.e., the sum of skews of all the nodes in MinCover(i,b).

First, the algorithm for calculating skewMinCover[n,B], shown in FIG. 3A, will be described in detail. skewMinCover[i,b] can be recursively defined as follows.

1) Case where a given node i is a leaf node, or b<k,

skewMinCover[i,b]=wSkew(i).

Here, k is the number of child nodes of the given node i.

2) Other cases

Let p_{i,j} denote the child node of i at the j-th position from the leftmost position, among the child nodes of i.

$${\sum }_{a = 1 … j} wSkew ( a cover of T ( {p}_{i , a} ) ) \qquad ( 3 )$$

Equation (3) indicates the sum of data skew values of a cover of T(p_{i,1}), a cover of T(P_{i,2}), . . . , a cover of T(P_{i,j}). Here, for each tree T(p_{i,a}), there can be more than one cover.

Let us define skewChildCover[i,j,b] as a minimal value of Equation (3) in the case where the condition of the following Equation (4) is satisfied.

$${\sum }_{a = 1 … j} \vert a cover of T ( {p}_{i , a} ) \vert \leq b \qquad ( 4 )$$

skewChildCover[i,j,b] can be recursively defined as follows.

1) Case where j=1

skewChildCover[i,l,b]=skewMinCover[p_{i,1},b] by definition.

2) Case where j≧2

The recursive definition of skewChildCover[i,j,b] is given by the following Equation (5).

$$skewChildCover [ i , j , b ] = {min}_{1 \leq r \leq b - j + 1} \{ skewMinCover [ {p}_{i , j} , r ] + skewChildCover [ i , j - 1 , b - r ] \} \qquad ( 5 )$$

In Equation (5), the value of r ranges over [1 . . . b−j+1], not [1 . . . b−1]. This is because at least one bucket has to be assigned to each child of i at the 1st, 2nd, . . . , j−1 th position from the leftmost position, among the child nodes of i.

Then, skewMinCover[i,b] is recursively defined by the following Equation (6) on the basis of skewChildCover[i,j,b] defined above.

$$skewMinCover [ i , b ] = \{ \begin{matrix}wSkew ( i ) & if node i is a leaf or b < k , \\ min \{ skewMinCover [ i , b - 1 ] , & skewChildCover [ i , k , b ] \} otherwise ,\end{matrix} \qquad ( 6 )$$

where wSkew(i) denotes the data skew value of the given node i, k denotes the number of child nodes of the node i, and skewChildCover[i,j,b] is

$$\{ \begin{matrix}skewMinCover [ {p}_{i , 1} , b ] & if j = 1 , \\ {min}_{1 \leq r \leq b - j + 1} \{ \begin{matrix}skewMinCover [ {p}_{i , j} , r ] + \\ skewChildCover [ i , j - 1 , b - r ]\end{matrix} \} & otherwise .\end{matrix}$$

Next, the algorithm for determining a minimal data-skew cover in T i.e., MinCover(n,B), shown in FIGS. 3B-1 and 3B-2, will be described in detail.

When sizeMinCover[i,b] denotes the number of nodes in a cover of T(i) such that the data skew value of the cover is skewMinCover[i,b], sizeMinCover[i,b] is recursively defined by the following Equation (7).

$$sizeMinCover [ i , b ] = \{ \begin{matrix}1 & if node i is a leaf or b < k , \\ sizeMinCover [ i , b - 1 ] & \begin{matrix}else if skewMinCover [ i , b - 1 ] \leq \\ skewChildCover [ i , k , b ] ,\end{matrix} \\ b & otherwise ,\end{matrix} \qquad ( 7 )$$

Further, sizeChildCover[i,j,b] is assumed to denote the number of nodes in a cover of T(p_{i,j}) in the case where the condition of the following equation is satisfied.

$${\sum }_{a = 1 … j} wSkew ( a cover of T ( {p}_{i , a} ) ) = skewChildCover [ i , b , j ] .$$

Then, sizeChildCover[i,j,b] is recursively defined by the following Equation (8).

$$sizeChildCover [ i , j , b ] = \{ \begin{matrix}sizeMinCover [ {p}_{i , 1} , b ] & if j = 1 , \\ sizeMinCover [ {p}_{i , j} , α ] & otherwise ,\end{matrix} \qquad ( 8 )$$

where α is a value calculated by equation

$${arg min}_{1 \leq r \leq b - j + 1} \{ skewMinCover [ {p}_{i , j} , r ] + skewChildCover [ i , j - 1 , b - r ] \}$$

Furthermore, numNodesMinCover[i] is assumed to denote the number of nodes included in both a minimal data-skew cover in T i.e., MinCover(n,B) and T(i).

Then, numNodesMinCover[i] is calculated based on sizeMinCover[i,b] and sizeChildCover[i,j,b] as follows. (Hereinafter, numNodesMinCover[i] will be represented by b[i]).

By definition, b[n] is sizeMinCover[n,B]. b[p_{n,k}] is sizeChildCover[n,k,b(n)]. Then, b[p_{n,k-1}] is sizeChildCover[n,k−1,b(n)-b(p_{n,k})]. As described above, the value of b[i] i.e., numNodesMinCover[i] is calculated in a top-down manner.

Then, a minimal data-skew cover in T i.e., MinCover(n,B) consists of nodes vⱼ of T that satisfies the two following conditions:

(i) numNodesMinCover of vⱼ is 1

(ii) vⱼ is a leaf node or the number of children vⱼ>1.

The above-described methods are advantageous because they provide superior accuracy for the estimation of the selectivity of multi-dimensional range queries.

Although the embodiments of the present invention have been disclosed for illustrative purposes, those skilled in the art will appreciate that various modifications, additions and substitutions are possible, without departing from the scope and spirit of the invention as disclosed in the accompanying claims. Therefore, all suitable modifications, additions and substitutions, and equivalents of the present invention should be interpreted as being included in the present invention.

What is claimed is:

1. A multi-dimensional histogram method using a minimal data-skew cover in a space-partitioning tree to estimate selectivity of queries, comprising:
(a) a database (DB) system receiving information required to generate a histogram from an outside of the DB system, and then constructing a space-partitioning tree based on the information required to generate a histogram;
(b) the DB system constructing a multi-dimensional histogram based on a minimal data-skew cover in the space-partitioning tree; and
(c) the DB system receiving a query from the outside, and then estimating selectivity of the quay by using the multi-dimensional histogram.

2. The multi-dimensional histogram method according to claim 1, wherein the information required to generate the histogram comprises one or more of an entire data space, a data set, a maximum number of buckets, and an index structure.

3. The multi-dimensional histogram method according to claim 2, wherein (a) comprises:
(a-1) the DB system receiving the entire data space, the data set and the maximum number of buckets as the information required to generate a histogram from the outside, and then partitioning the entire data space into one or more areas;
(a-2) the DB system computing the Minimum Bounding Regions (MBRs) of data objects in the partitioned areas, and constructing a space-partitioning tree, based on the computed MBRs; and
(a-3) calculating data skew values of respective nodes included in the space-partitioning tree.

4. The multi-dimensional histogram method according to claim 3, wherein (a-1) is performed to partition the entire data space into one or more areas by using one of a binary space partitioning method and a complete quadtree partitioning method.

5. The multi-dimensional histogram method according to claim 2, wherein (a) comprises:
(a′-1) the DB system receiving the index structure, the data set, and the maximum number of buckets as the information required to generate a histogram from the outside, and then using the index structure as a space-partitioning tree; and
(a′-2) calculating data skew values of respective nodes included in the space-partitioning tree.

6. The multi-dimensional histogram method according to claim 5, wherein (b) comprises:
(b-1) the DB system searching the space-partitioning tree for covers of the space-partitioning tree;
(b-2) the DB system determining a minimal data-skew cover with respect to a given cover in the space-partitioning tree, depending on whether a number of nodes included in the given cover in the space-partitioning tree is less than or equal to the externally received maximum number of buckets and whether a sum of data skew values of the respective nodes included in the given cover in the space-partitioning tree is a minimal value; and
(b-3) the DB system constructing a multi-dimensional histogram by organizing the nodes included in the minimal data-skew cover into histogram buckets.

7. The multi-dimensional histogram method according to claim 6, wherein the buckets of the multi-dimensional histogram are formed in shapes of hyperrectangles.

8. The multi-dimensional histogram method according to claim 6, wherein (c) is performed such that, for a data region I specified by a given range query, an estimate of the selectivity for the query is computed using the following equation:
$$estimate of the selectivity for a range query = {\sum }_{i = 1 … n} \frac{\vert {S}_{i} ⋀ I \vert}{\vert {S}_{i} \vert} \cdot {F}_{i} \qquad$$
where ‘| |’ denotes a size of a data space and ‘Sᵢ [symbol] I’ denotes an intersection of Sᵢ and I.

9. A recording medium storing a program for executing a multi-dimensional histogram method using a minimal data-skew cover in a space-partitioning tree to estimate selectivity of queries, the multi-dimensional histogram method comprising:
(a) a database (DB) system receiving information required to generate a histogram from an outside of the DB system, and then constructing a space-partitioning tree based on the information required to generate a histogram;
(b) the DB system constructing a multi-dimensional histogram based on a minimal data-skew cover in the space-partitioning tree; and
(c) the DB system receiving a query from the outside, and then estimating selectivity of the query by using the multi-dimensional histogram.

10. The recording medium according to claim 9, wherein the information required to generate the histogram comprises one or more of an entire data space, a data set, a maximum number of buckets, and an index structure.

11. The recording medium according to claim 10, wherein (a) comprises:
(a-1) the DB system receiving the entire data space, the data set and the maximum number of buckets as the information required to generate a histogram from the outside, and then partitioning the entire data space into one or more areas;
(a-2) the DB system computing the Minimum Bounding Regions (MBRs) of data objects in the partitioned areas, and constructing a space-partitioning tree, based on the computed MBRs; and
(a-3) calculating the data skew values of respective nodes included in the space-partitioning tree.

12. The recording medium according to claim 11, wherein (a-1) is performed to partition the entire data space into one or more areas by using one of a binary space partitioning method and a complete quadtree partitioning method.

13. The recording medium according to claim 10, wherein (a) comprises:
(a′-1) the DB system receiving the index structure, the data set, and the maximum number of buckets as the information required to generate a histogram from the outside, and then using the index structure as a space-partitioning tree; and
(a′-2) calculating the data skew values of respective nodes included in the space-partitioning tree.

14. The recording medium according to claim 13, wherein (b) comprises:
(b-1) the DB system searching the space-partitioning tree for covers of the space-partitioning tree;
(b-2) the DB system determining a minimal data-skew cover with respect to a given cover in the space-partitioning tree, depending on whether a number of nodes included in the given cover in the space-partitioning tree is less than or equal to the externally received maximum number of buckets and whether a sum of the data skew values of the respective nodes included in the given cover in the space-partitioning tree is a minimal value; and
(b-3) the DB system constructing a multi-dimensional histogram by organizing the nodes included in the minimal data-skew cover into histogram buckets.

15. The recording medium according to claim 14, wherein the buckets of the multi-dimensional histogram are formed in shapes of hyperrectangles.

16. The recording medium according to claim 14, wherein (c) is performed such that, for a data region I specified by a given range query, an estimate of the selectivity for the query is computed using the following equation:
$$estimate of the selectivity for a range query = {\sum }_{i = 1 … n} \frac{\vert {S}_{i} ⋀ I \vert}{\vert {S}_{i} \vert} \cdot {F}_{i} \qquad$$
where ‘| |’ denotes a size of a data space and ‘Sᵢ [symbol] I’ denotes an intersection of Sᵢ and I.

17. The recording medium according to claim 12, wherein (b) comprises:
(b-1) the DB system searching the space-partitioning tree for covers of the space-partitioning tree;
(b-2) the DB system determining a minimal data-skew cover with respect to a given cover in the space-partitioning tree, depending on whether a number of nodes included in the given cover in the space-partitioning tree is less than or equal to the externally received maximum number of buckets and whether a sum of the data skew values of the respective nodes included in the given cover in the space-partitioning tree is a minimal value; and
(b-3) the DB system constructing a multi-dimensional histogram by organizing the nodes included in the minimal data-skew cover into histogram buckets.

18. The recording medium according to claim 11, wherein (b) comprises:
(b-1) the DB system searching the space-partitioning tree for covers of the space-partitioning tree;
(b-2) the DB system determining a minimal data-skew cover with respect to a given cover in the space-partitioning tree, depending on whether a number of nodes included in the given cover in the space-partitioning tree is less than or equal to the externally received maximum number of buckets and whether a sum of the data skew values of the respective nodes included in the given cover in the space-partitioning tree is a minimal value; and
(b-3) the DB system constructing a multi-dimensional histogram by organizing the nodes included in the minimal data-skew cover into histogram buckets.

19. The multi-dimensional histogram method according to claim 4, wherein (b) comprises:
(b-1) the DB system searching the space-partitioning tree for covers of the space-partitioning tree;
(b-2) the DB system determining a minimal data-skew cover with respect to a given cover in the space-partitioning tree, depending on whether a number of nodes included in the given cover in the space-partitioning tree is less than or equal to the externally received maximum number of buckets and whether a sum of data skew values of the respective nodes included in the given cover in the space-partitioning tree is a minimal value; and
(b-3) the DB system constructing a multi-dimensional histogram by organizing the nodes included in the minimal data-skew cover into histogram buckets.

20. The multi-dimensional histogram method according to claim 3, wherein (b) comprises:
(b-1) the DB system searching the space-partitioning tree for covers of the space-partitioning tree;
(b-2) the DB system determining a minimal data-skew cover with respect to a given cover in the space-partitioning tree, depending on whether a number of nodes included in the given cover in the space-partitioning tree is less than or equal to the externally received maximum number of buckets and whether a sum of data skew values of the respective nodes included in the given cover in the space-partitioning tree is a minimal value; and
(b-3) the DB system constructing a multi-dimensional histogram by organizing the nodes included in the minimal data-skew cover into histogram buckets.
